(19) United States
(12) Patent Application Publication
(10) Pub. No.: US 2024/0066744 A1
(43) Pub. Date: Feb. 29, 2024

(54) CHAINSAW CHAINS

(71) Applicant: MILWAUKEE ELECTRIC TOOL CORPORATION, Brookfield, WI (US)

(72) Inventors: Carter A. Gibson, Wauwatosa, WI (US); Peter R. Heath, Wauwatosa, WI (US); John J. Springer, Milwaukee, WI (US); Ian H.A. Blair, Wauwatosa, WI (US); Scott T. Moeller, Richfield, WI (US); James E. Pangerc, Pewaukee, WI (US)

(21) Appl. No.: 18/454,164

(22) Filed: Aug. 23, 2023

Related U.S. Application Data
(60) Provisional application No. 63/400,476, filed on Aug. 24, 2022.

(51) Int. Cl. B27B 33/14

(52) U.S. Cl. CPC B27B 33/145

(57) ABSTRACT

A chainsaw chain includes a plurality of drive links, a plurality of cutters, and a plurality of rivets. Each drive link includes a drive link body, a pair of rivet holes extending through the drive link body, and a tang extending from the drive link body and configured to engage a drive element of a chainsaw. Each cutter includes a cutter body having a pair of rivet holes extending therethrough, a cutting tooth coupled to an upper portion of the cutter body, a feed limiter, and a gullet. The cutter body defines a longitudinal axis extending through the pair of rivet holes and a vertical axis oriented perpendicular to the longitudinal axis. The cutting tooth is set relative to the vertical axis. The plurality of rivets couples the plurality of drive links and the plurality of cutters together.

### CROSS-REFERENCE TO RELATED APPLICATIONS

The present application claims priority to U.S. Provisional Patent Application No. 63/400,476, filed Aug. 24, 2022, the entire content of which is incorporated herein by reference.

### FIELD OF THE INVENTION

The present invention relates to chainsaw chains.

### BACKGROUND OF THE INVENTION

A chainsaw chain typically includes cutters, drive links, tie straps, and rivets. The components of the chainsaw chain are coupled to each other in various patterns and are rotatably driven along a guide bar of the chainsaw to perform cutting operations.

### SUMMARY OF THE INVENTION

The invention provides, in one aspect, a chainsaw chain for a chainsaw. The chainsaw chain includes a plurality of drive links configured to connect the chainsaw chain to the chainsaw. Each drive link includes a drive link body, a pair of rivet holes extending through the drive link body, and a tang extending from the drive link body and configured to engage a drive element of the chainsaw. The chainsaw chain further includes a plurality of cutters configured to cut a workpiece during a cutting operation. Each cutter includes a cutter body having a pair of rivet holes extending therethrough. The cutter body defines a longitudinal axis extending through the pair of rivet holes and a vertical axis oriented perpendicular to the longitudinal axis. The cutter further includes a cutting tooth coupled to an upper portion of the cutter body. The cutting tooth of at least one of the plurality of cutters is set relative to the vertical axis of the cutter body. The cutter also includes a feed limiter coupled to the upper portion of the cutter body and spaced from the cutting tooth, and a gullet defined between the cutting tooth and the feed limiter. Moreover, the chainsaw chain includes a plurality of rivets received within corresponding rivet holes of the plurality of drive links and the plurality of cutters to couple the plurality of drive links and the plurality of cutters together.

This invention provides, in another aspect, a chainsaw chain for a chainsaw. The chainsaw chain consists of a plurality of drive links configured to support the chainsaw chain on the chainsaw. Each drive link includes a drive link body, a rivet hole extending through the drive link body, and a tang extending from the drive link body and configured to engage a drive element of the chainsaw. The chainsaw chain also consists of a plurality of cutters configured to cut a workpiece during a cutting operation. Each cutter includes a cutter body having a rivet hole extending therethrough, a cutting tooth coupled to an upper portion of the cutter body, a feed limiter coupled to the upper portion of the cutter body and spaced from the cutting tooth, and a gullet defined between the cutting tooth and the feed limiter. In addition, the chainsaw chain consists of a plurality of rivets received within corresponding rivet holes of the plurality of drive links and the plurality of cutters to couple the plurality of drive links and the plurality of cutters together.

This invention provides, in another aspect, a chainsaw chain for a chainsaw. The chainsaw chain includes a plurality of drive links configured to connect the chainsaw chain to the chainsaw. Each drive link includes a drive link body, a rivet hole extending through the drive link body, and a tang extending from the drive link body and configured to engage a drive element of the chainsaw. At least some of the plurality of drive links also include a cutting tooth extending from an edge of the drive link body opposite from the tang. The cutting tooth is configured to cut a workpiece during a cutting operation. The chainsaw chain further includes a plurality of cutters configured to cut the workpiece during the cutting operation. Each cutter includes a cutter body having a rivet hole extending therethrough and a cutting tooth coupled to the cutter body. Moreover, the chainsaw chain includes a plurality of rivets received within corresponding rivet holes of the plurality of drive links and the plurality of cutters to couple the plurality of drive links and the plurality of cutters together.

This invention provides, in another aspect, a chainsaw chain for a chainsaw. The chainsaw chain includes a plurality of drive links configured to connect the chainsaw chain to the chainsaw. Each drive link includes a drive link body, a rivet hole extending through the drive link body, and a tang extending from the drive link body and configured to engage a drive element of the chainsaw. The chainsaw chain further includes a plurality of cutters configured to cut a workpiece during a cutting operation. Each cutter includes a cutter body having a rivet hole extending therethrough, a cutting tooth coupled to an upper portion of the cutter body, a feed limiter coupled to the upper portion of the cutter body and spaced from the cutting tooth, and a gullet defined between the cutting tooth and the feed limiter. The plurality of cutters is positioned along both sides of the plurality of drive links in parallel such that the cutting tooth of a cutter positioned on a first side of the plurality of drive links is longitudinally aligned with the cutting tooth of an adjacent cutter positioned on a second side of the plurality of drive links. Moreover, the chainsaw chain includes a plurality of rivets received within corresponding rivet holes of the plurality of drive links and the plurality of cutters to couple the plurality of drive links and the plurality of cutters together.

Aspects of the invention will become apparent by consideration of the detailed description and the accompanying drawings.

### BRIEF DESCRIPTION OF DRAWINGS

FIG. 1 is a perspective view of a chainsaw.

FIG. 2 is a perspective view of a chainsaw chain according to an embodiment of the present invention.

FIG. 3 is a side view of a cutter according to an embodiment of the present invention.

FIG. 4 is a perspective view of a drive link according to an embodiment of the present invention.

FIG. 5 is a perspective view of a tie strap according to an embodiment of the present invention.

FIG. 6 is a perspective view of a cutter according to another embodiment, the cutter having a cutting tooth similar to a cutting tooth of a hole saw blade.

FIG. 7 is a rear view of the cutter of FIG. 6, the cutting tooth is set in a right direction.

FIG. 8 is a perspective view of a cutter according to another embodiment, the cutter having a cutting tooth similar to a cutting tooth of a hole saw blade.

FIG. 9 is a front view of the cutter of FIG. 8, the cutting tooth is set in a left direction.

FIG. 10 is a perspective view of a cutter according to another embodiment, the cutter having a cutting tooth similar to a cutting tooth of a hole saw blade.

FIG. 11 is a front view of the cutter of FIG. 10, the cutting tooth is unset.

FIG. 12 is a perspective view of a chainsaw chain according to another embodiment of the present invention.

FIG. 13 is a perspective view of a cutter according to another embodiment, the cutter having a cutting tooth similar to a cutting tooth of a circular saw blade.

FIG. 14 is a perspective view of the cutter of FIG. 13.

FIG. 15 is a side view the cutter of FIG. 13.

FIG. 16 is a side view of a cutter according to another embodiment, of FIG. 1 the cutter having a cutting tooth similar to a cutting tooth of a reciprocating saw blade.

FIG. 17 is a perspective view of a chainsaw chain according to another embodiment of the present invention, the chainsaw including a plurality of cutters similar to the cutter of FIG. 16.

FIG. 18 is an enlarged perspective view of a portion of the chainsaw chain of FIG. 17.

FIG. 19 is a top view of the portion of the chainsaw chain of FIG. 18.

FIG. 20 is a perspective view of a chainsaw chain according to another embodiment of the present invention.

FIG. 21 is a perspective view of a center cutter.

FIG. 22 is another perspective view of the center cutter of FIG. 21.

FIG. 23 is a side view of a drive link, one embodiment of a center cutter, and another embodiment of a center cutter.

FIG. 24 is a perspective view of a chainsaw chain according to another embodiment of the present invention.

FIG. 25 is a front view of the chainsaw chain of FIG. 24.

FIG. 26 is a perspective view of a chainsaw chain according to another embodiment of the present invention.

FIG. 27 is a top perspective view of the chainsaw chain of FIG. 26.

FIG. 28 is a front view of a cutter according to another embodiment of the present invention, the cutter having a cutting tip set at a first magnitude and in a left direction.

FIG. 29 is a front view of a cutter according to another embodiment of the present invention, the cutter having a cutting tip set at a second magnitude and in a left direction.

FIG. 30 is a front view of a cutter according to another embodiment of the present invention, the cutter having a cutting tip set at a first magnitude and in a right direction.

FIG. 31 is a front view of a cutter according to another embodiment of the present invention, the cutter having a cutting tip set at a second magnitude and in a right direction.

FIG. 32 is an enlarged view of a portion of a chainsaw chain according to another embodiment of the present invention.

FIG. 33 is a top view of a portion of the chainsaw chain of FIG. 32.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

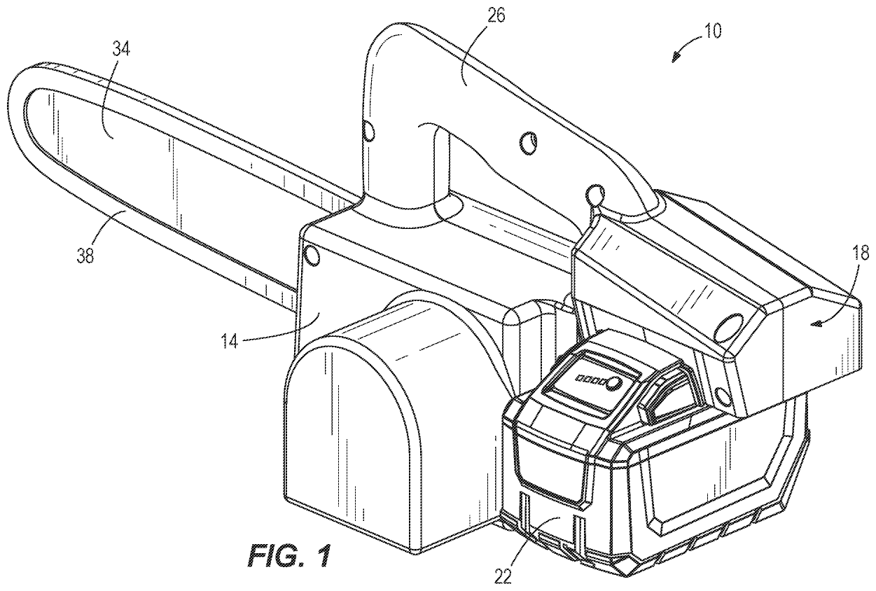

FIG. 1 illustrates a chainsaw 10 configured to perform cutting operations on a workpiece. The chainsaw 10 includes a housing 14 configured to support a motor and a drive mechanism, a battery receptacle 18 coupled to a rear portion of the housing 14, a power source 22 coupled to the battery receptacle 18, a handle 26 coupled to the housing 14 and the battery receptacle 18, a trigger coupled to the handle 26, and a guide bar 34 coupled to a front portion of the housing 14. In the illustrated embodiment, the power source 22 is a battery pack, such as an 18-volt Li-ion battery pack. The battery pack is configured to selectively supply power to the motor to activate the chainsaw 10. In other embodiments, the chainsaw 10 may have other types of power sources, such as a gasoline engine or an AC power cord. A chainsaw chain 38 is disposed along a periphery of the guide bar 34 and configured to be rotatably driven by the motor and the drive mechanism when the trigger is moved from an OFF position to an ON position. As the chainsaw chain 38 is driven along the guide bar 34, a user is able to perform cutting operations on material such as wood.

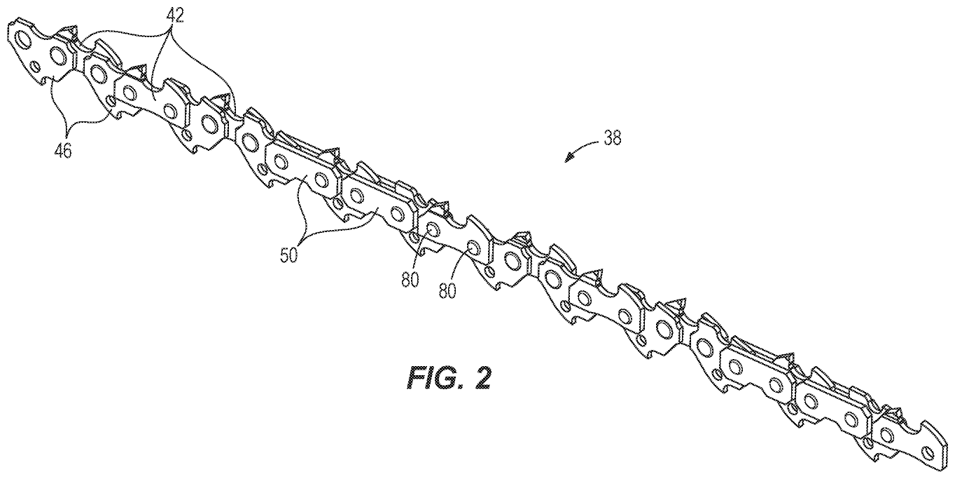

FIG. 2 illustrates an embodiment of the chainsaw chain 38. The illustrated chainsaw chain 38 includes a plurality of cutters 42, a plurality of drive links 46 positioned at a central portion of the chainsaw chain 38, and a plurality of tie straps 50 or tie links that interconnect consecutive drive links of the plurality of drive links 46. The cutters 42, the drive links 46 and the tie straps 50 are each coupled to each other by rivets 80. In some embodiments, the rivets 80 may undergo deformation to permanently couple the components of the chainsaw chain 38 together. In other embodiments, the cutters 42, the drive links 46 and the tie straps 50 may be coupled together by other suitable fasteners. Various cutting patterns of the chainsaw chain 38 are defined by the positioning of the cutters 42, the drive links 46, and the tie straps 50 and will be discussed herein below. Although different constructions and configurations of cutters, drive links, and tie straps are discussed separately below, the cutters, drive links, and tie straps may be used in any combination to form a chainsaw chain. Features of one cutter, drive link, or tie strap are equally applicable to another cutter, drive link, or tie strap.

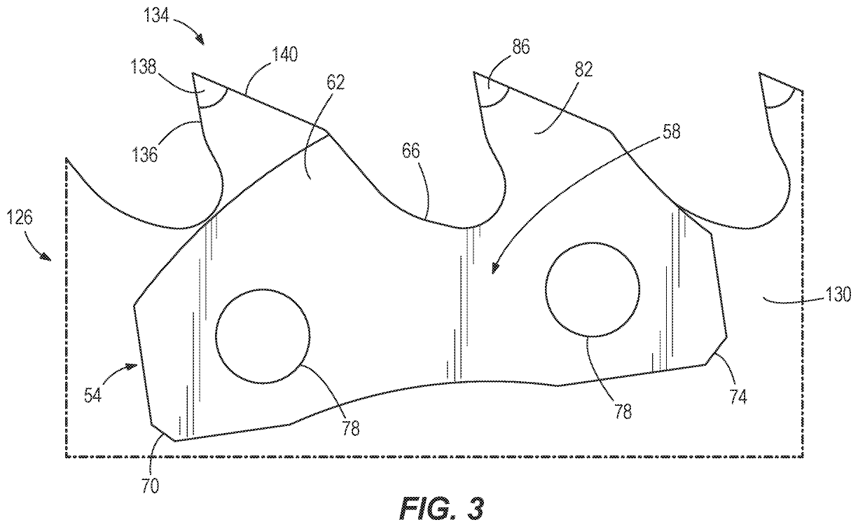

FIG. 3 illustrates an embodiment of a cutter 54. The cutter 54 includes a cutter body 58, a cutting tooth 82, a feed limiter 62 or a depth gauge, a gullet 66, a toe 70, and a heel 74. The cutter body 58 includes one or more rivets holes 78 extending therethrough. Each rivet hole 78 is configured to receive a rivet 80 (FIG. 2). The cutting tooth 82 is coupled to and extends from an upper portion of the cutter body 58. In the illustrated embodiment, the cutting tooth 82 is integrally formed with the cutter body 58. In other embodiments, the cutting tooth 82 may be a separate piece that is secured to the cutter body 58. The feed limiter 62 is also coupled to and extends from the upper portion of the cutter body 58. The feed limiter 62 is spaced apart from the cutting tooth 82 in front of the cutting tooth 82 in a cutting direction. In the illustrated embodiment, the feed limiter 62 is integrally formed with the cutter body 58. In other embodiments, the feed limiter 62 may be a separate piece that is secured to the cutter body 58. The feed limiter 62 is configured to limit how far the cutting tooth 82 can cut into a workpiece. The gullet 66 is defined between the cutting tooth 82 and the feed limiter 62. The toe 70 and the heel 74 are formed along a bottom portion of the cutter body 58. The toe 70 is positioned closer to the feed limiter 62, while the heel 74 is positioned closer to the cutting tooth 82. In the illustrated embodiment, each of the toe 70 and the heel 74 is formed as a chamfer-like edge.

The cutting tooth 82 of the cutter 54 is the portion of the chainsaw chain 38 that performs the cutting operation. The cutting tooth 82 includes a cutting tip 86 secured to a top portion of the cutting tooth 82. In some embodiments, the cutting tip 86 may be secured by various welding methods (e.g., brazing, resistance welding, laser welding, cladding, etc.). After the cutting tip 86 is secured to the cutting tooth 82, the cutting tip 86 may then be ground to a desired shape.

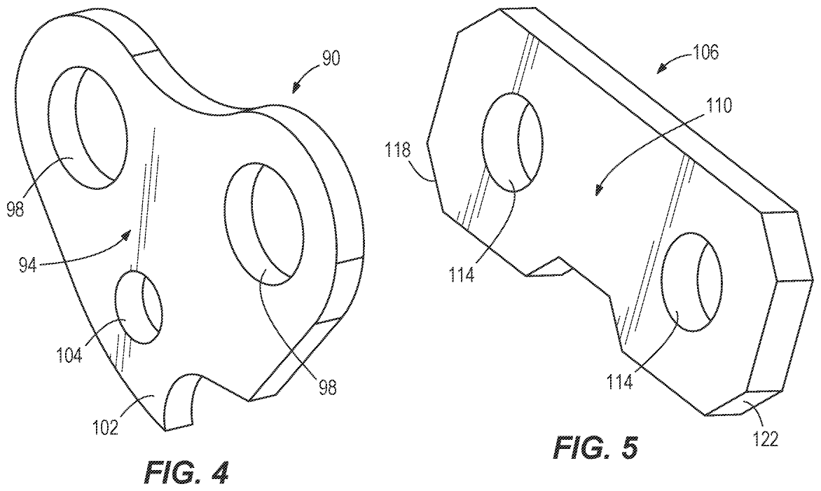

FIG. 4 illustrates one drive link 90 of the plurality of drive links 46. The drive link 90 includes a drive link body 94, one or more rivet holes 98 extending through the drive link body 94, and a tang 102 positioned below the pair of rivet holes 98. The rivet holes 98 are each configured to receive a rivet 80 (FIG. 2), so that the drive link 90 can be coupled to the cutter 54 and/or a tie strap 106 (FIG. 5). The tang 102 extends downwardly from the drive link body 94. In the illustrated embodiment, the tang 102 is integrally formed with the drive link body 94. In other embodiments, the tang 102 may be a separate piece that is secured to the drive link body 94. The tang 102 is defined by a curved gap formed within the drive link body 94 and is configured to support the chainsaw chain 38 along the guide bar 34 of the chainsaw 10. The tang 102 also engages a drive element moving within the guide bar 34 to drive the chainsaw chain 38 around the guide bar 34 and carry lubricating fluid (e.g., oil) through the guide bar 34 to keep the chainsaw chain 38 lubricated. The drive link 90 further includes an opening 104 proximate the tang 102. The opening 104 also carries and spreads lubricating fluid through the guide bar 34. Therefore, the chainsaw chain 38 can remain lubricated and attached to the guide bar 34 during operation of the chainsaw 10.

FIG. 5 illustrates one tie strap 106 of the plurality of tie straps 50. The tie strap 106 includes a tie strap body 110, one or more rivet holes 114 extending through the tie strap body 110, a toe 118, and a heel 122. The tie strap 106 is configured to interconnect the drive link 90 to the cutter 54 or consecutive drive links 46 to form the chainsaw chain 38. For example, one of the rivet holes 114 of the tie strap 106 may align with one of the rivet holes 98 of the drive link 90, while the other of the rivet holes 114 of the tie strap 106 may align with one of the rivet holes 78 of the cutter 54.

Referring back to FIG. 2, the chainsaw chain 38 is formed by coupling the plurality of cutters 42 to the plurality of drive links 46, and also coupling the plurality of drive links 46 to the plurality of tie straps 50. One of the rivet holes 78 of the cutter 54 is aligned and coaxial with one of the rivet holes 98 of the drive link 90, so that the rivet 80 can be received through the aligned rivet holes 78, 98 of the cutter 54 and the drive link 90. The rivet 80 may be deformed to permanently couple the cutter 54 to the drive link 90. The same process can also be used to permanently couple the tie strap 106 and the drive link 90 together.

To deform the rivet 80 such that the cutter 54, the drive link 90, and the tie strap 106 are coupled to each other, the rivet 80 can be forged. The rivet 80 includes a rivet head having a first diameter, a rivet end opposite the rivet head, and a rivet shaft having a second diameter and disposed between the rivet head and the rivet end. Once the rivet 80 is received through corresponding rivet holes 78, 98, 114, either the cutter 54, the drive link 90, or the tie strap 106 is placed along the rivet shaft as the rivet head is positioned against a surface of either the cutter 54, the drive link 90, or the tie strap 106. The rivet end can then be deformed, such that the rivet end is enlarged to a third diameter about two times larger than the second diameter of the rivet shaft. After the rivet end has been deformed, the cutter 54, the drive link 90, and the tie strap 106 are then enclosed between the rivet head and the rivet end and permanently coupled to each other.

Referring back to FIG. 3, the cutter 54 is compared to a hole saw blade 126. In particular, an outline of the cutter 54 is superimposed on a surface of the hole saw blade 126. The hole saw blade 126 includes a saw blade body 130 and a plurality of cutting teeth 134. Each cutting tooth 134 has a blade cutting tip 138 coupled to a top portion of the cutting tooth 134, a rake face 136 extending from the blade cutting tip 138, and a relief face 140 extending from the blade cutting tip 138. As illustrated, the cutting tooth 134 of the cutter 54 adopts the shape and size of one of the cutting teeth 134 of the hole saw blade 126. The feed limiter 62 of the cutter 54 also fits within the profile of an adjacent cutting tooth 134 of the hole saw blade 126, but is shaped to not include a cutting tip. With such an arrangement, the cutter 54 can create relatively smoother cuts like a hole saw, rather than rougher cuts like a conventional chainsaw.

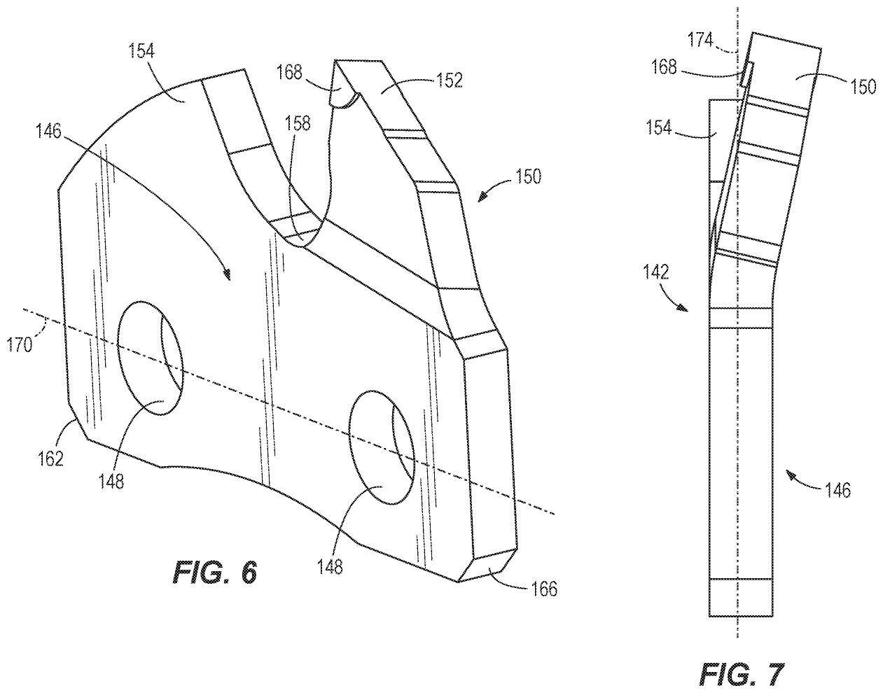

FIGS. 6-9 illustrate multiple embodiments of a cutter. In these embodiments, a cutting tooth of a cutter is set (i.e., bent) in either a right direction or a left direction. Thus, each cutting tooth is oriented at an oblique angle relative to a cutter body of respective cutters.

FIGS. 6 and 7 illustrate an embodiment of a cutter 142. The cutter 142 includes a cutter body 146 having one or more rivet holes 148 extending therethrough, a cutting tooth 150, a cutting tip 152 coupled to the cutting tooth 150, a feed limiter 154, a gullet 158, a toe 162, and a heel 166. The cutter 142 further includes a projection 168 extending from the cutting tip 152. The projection 168 represents a cutting tip 152 that is wider than the cutting tooth 150. The projection 168 may extend further from one side of the cutting tooth 150 than the other side or may extend equal distances from both sides of the cutting tooth 150. In other embodiments, the cutting tip 152 may have the same width as the cutting tooth 150. The cutter body 146 defines a longitudinal axis 170 of the cutter 142 and a vertical axis 174 of the cutter 142. The longitudinal axis 170 extends through the rivet holes 148, while the vertical axis 174 is oriented perpendicular to the longitudinal axis 170. The cutting tooth 150 of the cutter 142 is set in the right direction, such that the cutting tooth 150 is non-parallel to the vertical axis 174 of the cutter 142, as the feed limiter 154 is parallel to the vertical axis 174. For example, the cutting tooth 150 may be set between 5 degrees and 15 degrees relative to the vertical axis 174. Thus, the cutting tooth 150 is oriented at a first oblique angle relative to the cutter body 146 of the cutter 142. In some embodiments, the cutting tip 152 can be formed of carbide. However, in other embodiments, the cutting tip 152 can be formed of other materials.

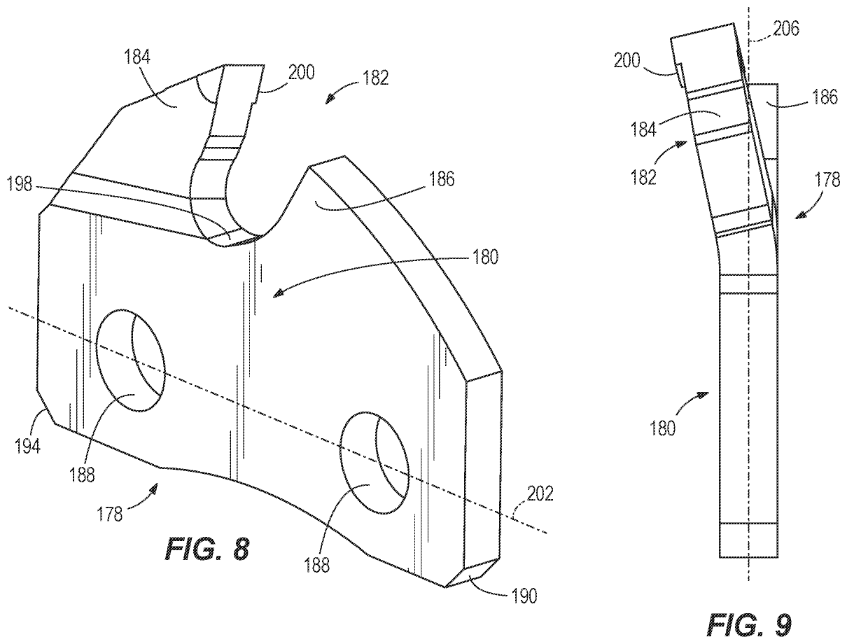

FIGS. 8 and 9 illustrate another embodiment of a cutter 178. The cutter 178 includes a cutter body 180, a cutting tooth 182, a cutting tip 184 coupled to the cutting tooth 182, a feed limiter 186, one or more rivet holes 188 extending through the cutter body 180, a toe 190, a heel 194, and a gullet 198 positioned between the feed limiter 186 and the cutting tooth 182. The cutter 178 further includes a projection 200 extending from a surface of the cutting tip 184. The projection 200 represents a cutting tip 184 that is wider than the cutting tooth 182. The projection 200 may extend further from one side of the cutting tooth 182 than the other side or may extend equal distances from both sides of the cutting tooth 182. In other embodiments, the cutting tip 184 may have the same width as the cutting tooth 182. A longitudinal axis 202 of the cutter 178 is defined by the cutter body 180 and extends through the rivet holes 188. A vertical axis 206 of the cutter 178 is also defined by the cutter body 180 and is oriented perpendicular to the longitudinal axis 202. The cutting tooth 182 of the cutter 178 is set in the left direction and non-parallel to the vertical axis 206. For example, the cutting tooth 182 may be set between 5 degrees and 15 degrees relative to the vertical axis 348. The cutting tooth 182 is thereby oriented at another oblique angle relative to the cutter body 180 of the cutter 178. The cutting tip 184 can be formed of carbide. Although, the cutting tip 184 is not limited to carbide, and can therefore be other materials.

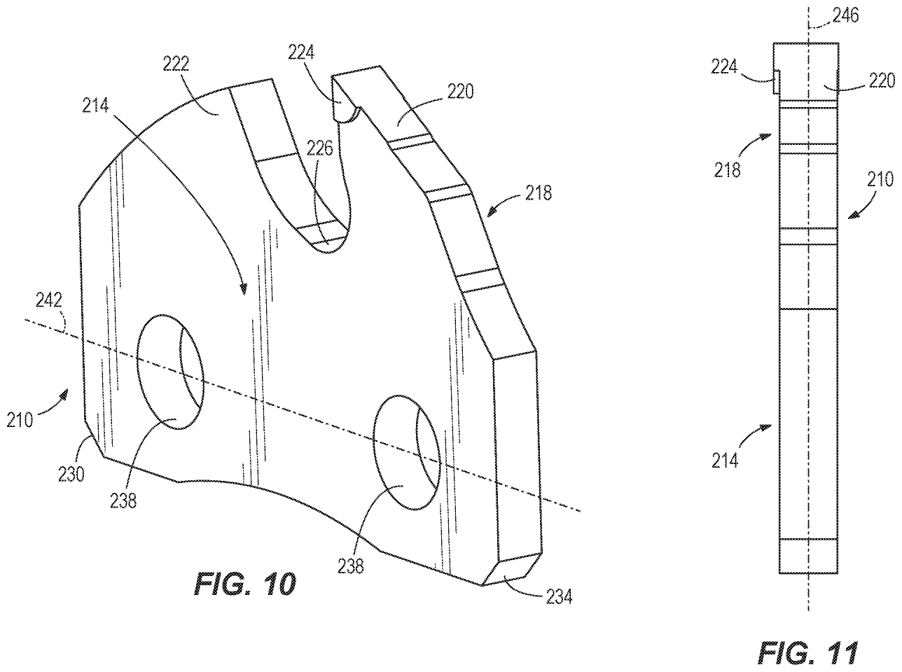

FIGS. 10 and 11 illustrate another embodiment of a cutter 210. The cutter 210 includes a cutter body 214, a cutting tooth 218 having a cutting tip 220, a feed limiter 222, a projection 224 extending from a surface of the cutting tip 220, a gullet 226, a toe 230, and a heel 234. The cutter body 214 includes one or more rivet holes 238 extending therethrough and defines a longitudinal axis 242 of the cutter 210 extending through the rivet holes 238. A vertical axis 246 of the cutter 210 is also defined by the cutter body 214 and is oriented perpendicular to the longitudinal axis 242. The feed limiter 222 and the cutting tooth 218 are integrally formed with the cutter body 214 and opposite each other with a space defined therebetween. The cutting tooth 218 is unset, such that the cutting tooth 218 is oriented parallel to the vertical axis 246, as well as the feed limiter 222.

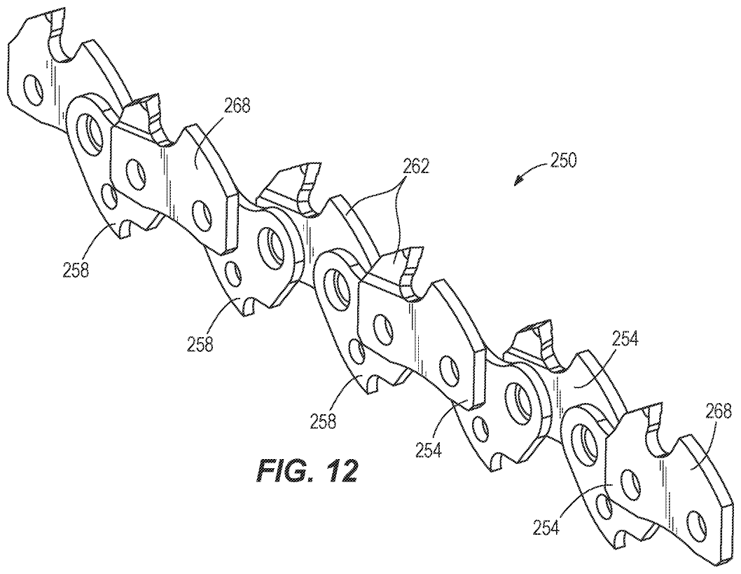

FIG. 12 illustrates another embodiment of a chainsaw chain 250. The chainsaw chain 250 includes a plurality of cutters 254 and a plurality of drive links 258 positioned at a central portion of the chainsaw chain 250. The plurality of cutters 254 is positioned along respective sides of the drive links 258 and a space is defined between consecutive cutters 254. The plurality of cutters 254 includes a first set of cutters 262 having cutting teeth that extend in a right direction and a second set of cutters 268 having cutting teeth that extend in a left direction. The cutters 254 are configured to have a shape similar to the cutters 254 of FIGS. 6-9. In some embodiments, the first set of cutters 262 and the second set of cutters 268 are oriented at various oblique angles. In other embodiments, the first set of cutters 262 and the second set of cutters 268 are oriented at the same oblique angle.

A cutting pattern of the chainsaw chain 250 is defined by the first set of cutters 262 and the second set of cutters 268, in which the cutting pattern alternates between a cutter of the first set of cutters 262 and a cutter of the second set of cutters 268. In some embodiments, the cutting teeth of the first set of cutters 262 and the second set of cutters 268 are oriented to hang over the central portion of the chainsaw chain 250. In other embodiments of the chainsaw chain 250, the first set of cutters 262 and the second set of cutters 268 are oriented to extend in a direction opposite the central portion of the chainsaw chain 250.

In the illustrated embodiment of the chainsaw chain 250, the first set of cutters 262 and the second set of cutters 268 are configured to extend in a direction opposite the central portion, as well as extend over the central portion of the chainsaw chain 250. Having the plurality of cutters 254 extend in either the right direction or the left direction allows the chainsaw chain 250 to make even cuts along a workpiece as the chainsaw chain 250 cuts from the left direction and the right direction. In another embodiment of the chainsaw chain 250, the plurality of cutters 254 includes cutters with cutting teeth that are unset, similar to the cutter 210 of FIGS. 10 and 11.

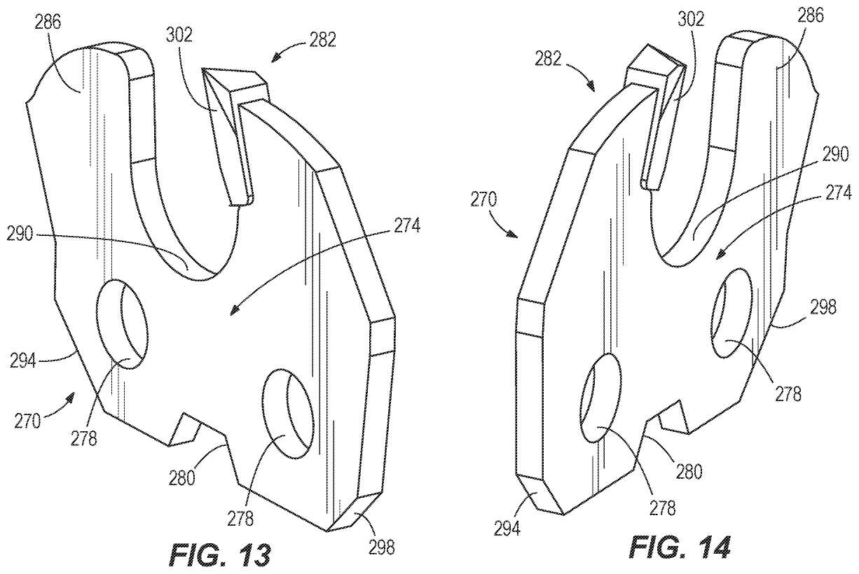

FIGS. 13-15 illustrate another embodiment of a cutter 270. The cutter 270 includes a cutter body 274 having one or more rivet holes 278 extending therethrough, a cutting tooth 282, a feed limiter 286, a gullet 290, a toe 294, and a heel 298. The gullet 290 is positioned between the cutting tooth 282 and the feed limiter 286. The cutting tooth 282 and the feed limiter 286 are integrally formed to a top portion of the cutter body 274. The toe 294 and the heel 298 are integrally formed along a bottom portion of the cutter body 274. The cutting tooth 282 is proximate the heel 298, while the feed limiter 286 is proximate the toe 294. A recess 280 is defined along the bottom portion of the cutter body 274, between the toe 294 and the heel 298.

The cutting tooth 282 includes a cutting tip 302 coupled to a top portion of the cutting tooth 282. The cutting tip 302 can be coupled to the cutting tooth 282 by various welding methods (e.g., brazing, resistance welding, laser welding, cladding, etc.) and formed of various materials, such as carbide. Once the cutting tip 302 is secured to the cutting tooth 282, the cutting tip 302 can be ground to a desired shape. In this case, the cutting tip 302 is ground such that the cutting tooth 282 has a shape and size similar to a cutting tooth of a circular saw blade. As such, the cutting tip 302 is arranged to provide a wide cutting tooth that covers a cross-section of the guide bar 34 of the chainsaw 10.

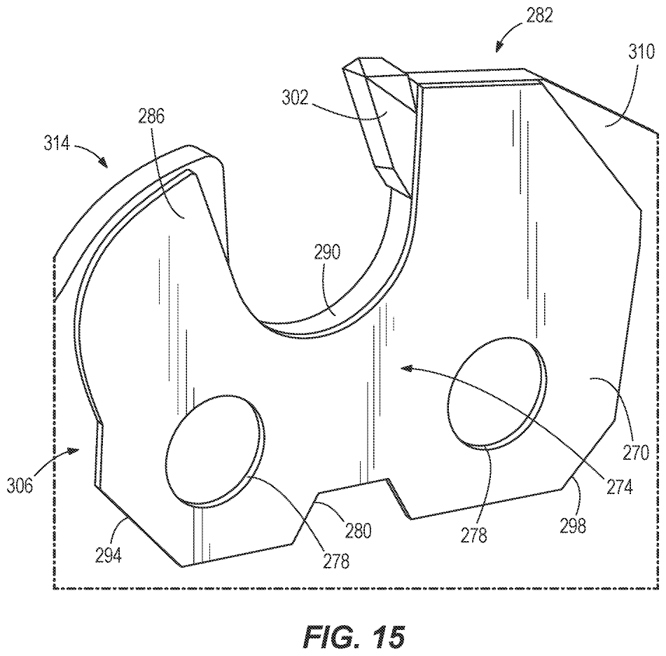

FIG. 15 illustrates the cutter 270 compared to a circular saw blade 306. In particular, an outline of the cutter 270 is superimposed on a surface of the circular saw blade 306. The circular saw blade 306 includes a blade body 310 and a plurality of cutting teeth 314 integrally formed along the blade body 310. The cutting tooth 282 of the cutter 270 takes the form of one of the cutting teeth 314 defined along the circular saw blade 306. The feed limiter 286 of the cutter 270 also fits within the profile of a feed limiter of the circular saw blade 306, but is shaped to increase a size of the gullet 290 between the cutting tooth 282 and the feed limiter 286. Having a cutting tooth similar to the structure of the cutting teeth 314 of the circular saw blade 306 allows the chainsaw 10 to provide a cut with a narrow kerf.

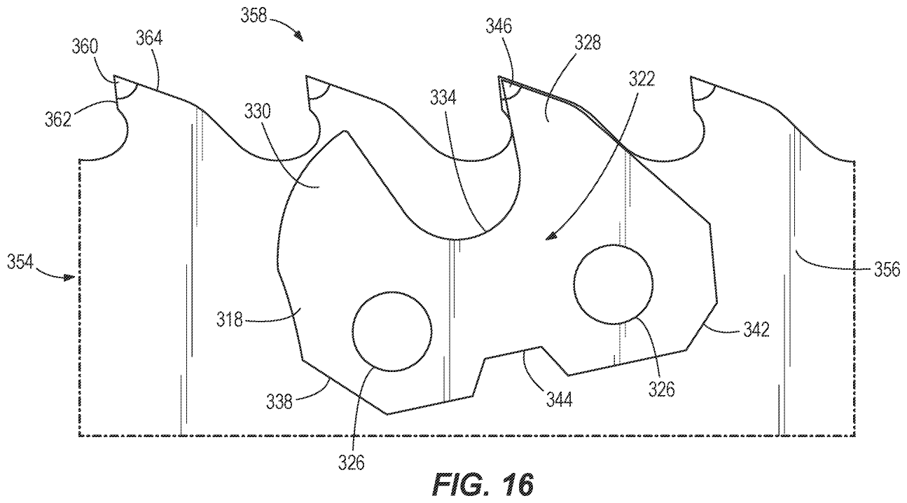

FIG. 16 illustrates another embodiment of a cutter 318. The cutter 318 includes a cutter body 322 having one or more rivet holes 326 extending therethrough, a cutting tooth 328, a feed limiter 330, a gullet 334, a toe 338 proximate the feed limiter 330, and a heel 342 proximate the cutting tooth 328. Along a top portion of the cutter body 322, the cutting tooth 328 and the feed limiter 330 are integrally formed. The toe 338 and the heel 342 are integrally formed to a bottom portion of the cutter body 322. The gullet 334 is positioned between the feed limiter 330 and the cutting tooth 328. The cutter 318 further includes a recess 344 formed along a bottom portion of the cutter body 322, between the toe 338 and the heel 342.

The cutting tooth 328 includes a cutting tip 346 coupled to a top portion of the cutting tooth 328 by various welding methods (e.g., brazing, resistance welding, laser welding, cladding, etc.). After the cutting tip 346 is secured to the cutting tooth 328 and ground to a desired shape, the cutting tip 346 is formed to have a shape and size similar to a cutting tooth of a reciprocating saw blade 354.

In FIG. 16, the cutter 318 is compared to the reciprocating saw blade 354. In particular, an outline of the cutter 318 is superimposed on a surface of the reciprocating saw blade 354. The reciprocating saw blade 354 includes a blade body 356 and a plurality of cutting teeth 358 formed along a top portion of the blade body 356. Each cutting tooth 358 has a blade cutting tip 360 coupled to a top portion of the cutting tooth 358, a rake face 362 extending from the blade cutting tip 360, and a relief face 364 extending from the blade cutting tip 360. The cutting tooth 328 of the cutter 318 has a shape and size similar to one of the cutting teeth 358 of the reciprocating saw blade 354. The feed limiter 330 of the cutter 318 fits within the profile of an adjacent cutting tooth 358, but is significantly reshaped relative to the cutting tooth 358. In addition, the gullet 334 of the cutter 318 is significantly larger than a corresponding gullet of the reciprocating saw blade 354. With such an arrangement, the cutting tooth 328 is configured to have a thin tip and can create relatively smoother cuts like a reciprocating saw blade.

In one embodiment of the cutter 318, the cutting tooth 328 is configured to be set in a right direction. In another embodiment of the cutter 318, the cutting tooth 328 is configured to be set in a left direction. When set in either the right direction or the left direction, the cutting tooth 328 is oriented to be non-parallel to a vertical axis of the cutter 318. Therefore, the cutting tooth 328 is oriented at a first oblique angle relative to the vertical axis of the cutter 318 as the cutting tooth 328 extends in the right direction and at a second oblique angle relative to the vertical axis of the cutter 318 as the cutting tooth 328 extends in the left direction. In other embodiments of the cutter 318, the cutting tooth 328 can be structured to extend upward and parallel to the vertical axis of the cutter 318 (i.e., the cutting tooth 328 can be unset). In one embodiment of the cutter 318, the cutting tip 346 is made of carbide. While in other embodiments of the cutter 318, the cutting tip 346 can be made of other materials depending upon the welding method used to couple the cutting tip 346 to the cutting tooth 328.

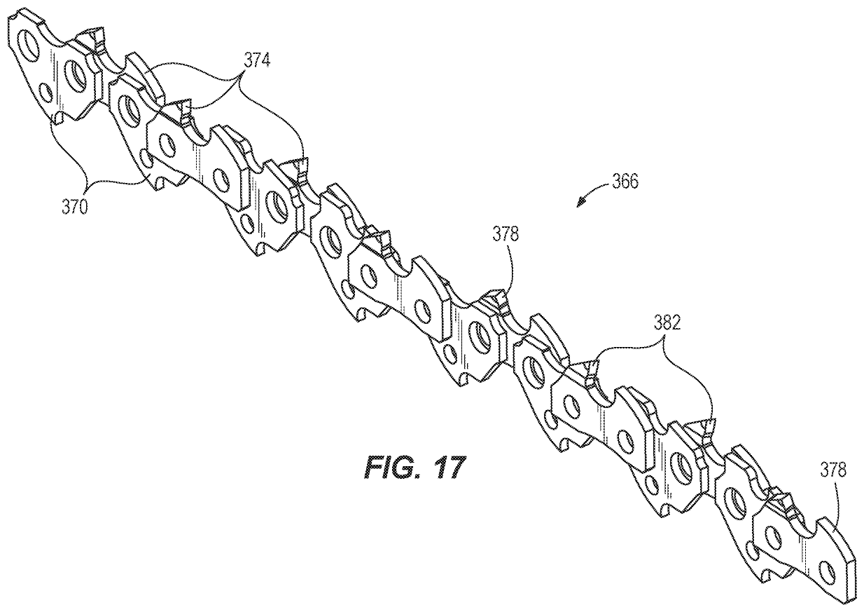

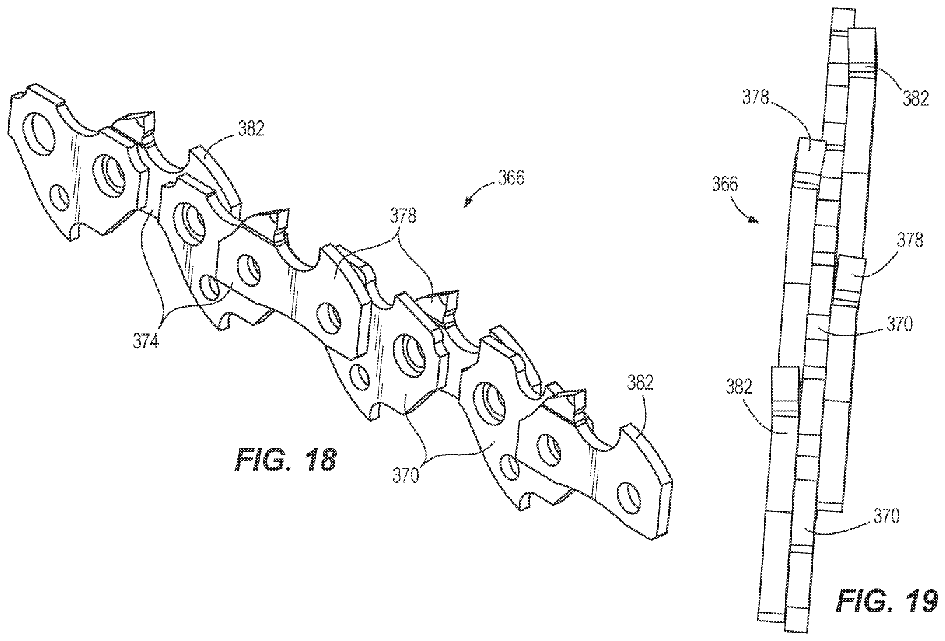

FIGS. 17-19 illustrate another embodiment of a chainsaw chain 366. The chainsaw chain 366 includes a plurality of drive links 370 and a plurality of cutters 374. The plurality of drive links 370 is positioned along a central portion of the chainsaw chain 366, as the plurality of cutters 374 is positioned along each side of respective drive links 370. A space is provided between consecutive cutters of the plurality of cutters 374. The plurality of drive links 370 and the plurality of cutters 374 are coupled to each other by rivets. The plurality of cutters 374 includes a first set of cutters 378 and a second set of cutters 382 having a similar shape and size to the cutter of FIG. 16. The first set of cutters 378 has cutting teeth set in a right direction, while the second set of cutters 382 has cutting teeth set in a left direction. In other embodiments of the chainsaw chain 366, the plurality of cutters 374 includes cutting teeth configured to extend upward and parallel to a vertical axis of respective cutters 374.

In a cutting pattern of the chainsaw chain 366, the first set of cutters 378 alternates with the second set of cutters 382. The first set of cutters 378 and the second set of cutters 382 are oriented to overlap the central portion of the chainsaw chain 366. Alternatively, the first set of cutters 378 and the second set of cutters 382 are oriented to extend in a direction opposite the central portion of the chainsaw chain 366. In the illustrated embodiment of the chainsaw chain 366, the first set of cutters 378 and the second set of cutters 382 are oriented to overlap the central portion of the chainsaw chain 366 and extend away from the central portion of the chainsaw chain 366.

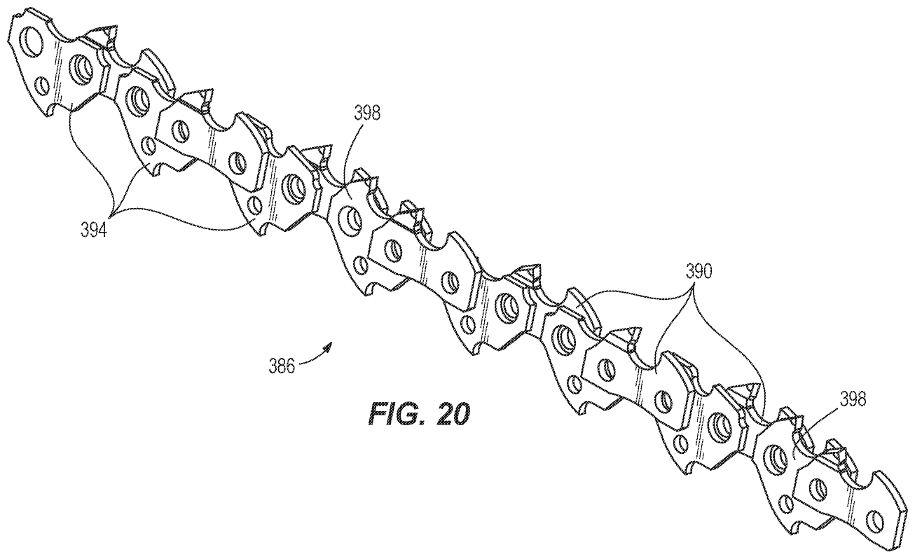

FIG. 20 illustrates another embodiment of a chainsaw chain 386. The chainsaw chain 386 includes a plurality of cutters 390, a plurality of drive links 394, and a plurality of center cutters 398. The plurality of drive links 394 and the plurality of center cutters 398 are positioned along a central portion of the chainsaw chain 386. The plurality of cutters 390 is positioned along each side of the drive links 394 and the center cutters 398. The plurality of cutters 390, the plurality of drive links 394, and the plurality of center cutters 398 are coupled to each other by rivets. The plurality of cutters 390 is similar to the cutter 318 of FIG. 16.

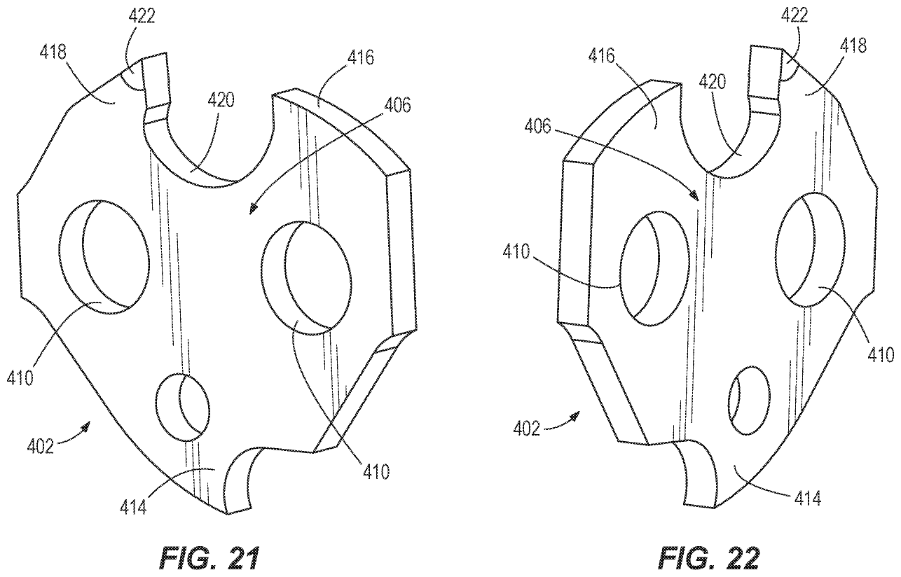

FIGS. 21 and 22 illustrate one center cutter 402 of the plurality center cutters 398. The center cutter 402 is also a drive link. The center cutter 402 includes a center cutter body 406, one or more rivet holes 410 extending through the center cutter body 406, a tang 414 integrally formed along a bottom portion of the center cutter body 406, and a cutting tooth 418 integrally formed along a top portion of the center cutter body 406 and opposite the tang 414. The cutting tooth 418 includes a cutting tip 422 coupled to the cutting tooth 418 by various welding methods (e.g., brazing, resistance welding, laser welding, cladding, etc.) and ground to a desired shape. The shape of the cutting tip 422 is similar to the cutting tip 346 of FIG. 16. Additionally, the cutting tip 422 may be formed of carbide; however, the material of the cutting tip 422 is not limited to carbide and can be other materials. The center cutter 402 further includes a feed limiter 416 spaced from and opposite the cutting tooth 418, and a gullet 420 defined between the cutting tooth 418 and the feed limiter 416. Having the tang 414 and the cutting tip 422 integrally formed with the center cutter body 406 of each center cutter 402 allows the plurality of center cutters 398 to simultaneously serve as a cutter and a drive link. Therefore, the center cutter 402 is configured to perform cutting operations, as well as maintain the chainsaw chain 386 along the guide bar 34 of the chainsaw 10.

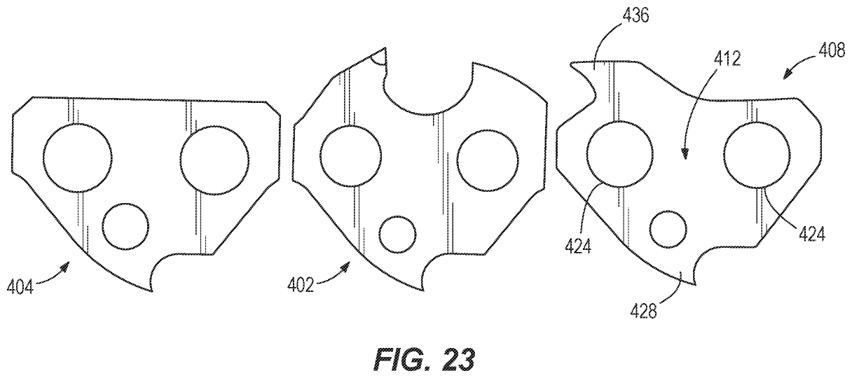

FIG. 23 illustrates the center cutter 402, one drive link 404 of the drive links 394, and another embodiment of a center cutter 408. The center cutter 408 includes a center cutter body 412, one or more rivet holes 424, a tang 428, and a cutting tooth 436. The tang 428 is integrally formed with a bottom portion of the center cutter body 412, while the cutting tooth 436 is integrally formed with a top portion of the cutting tooth 436. Even without a feed limiter and a gullet, the center cutter 402 can still serve as a cutter and a drive link.

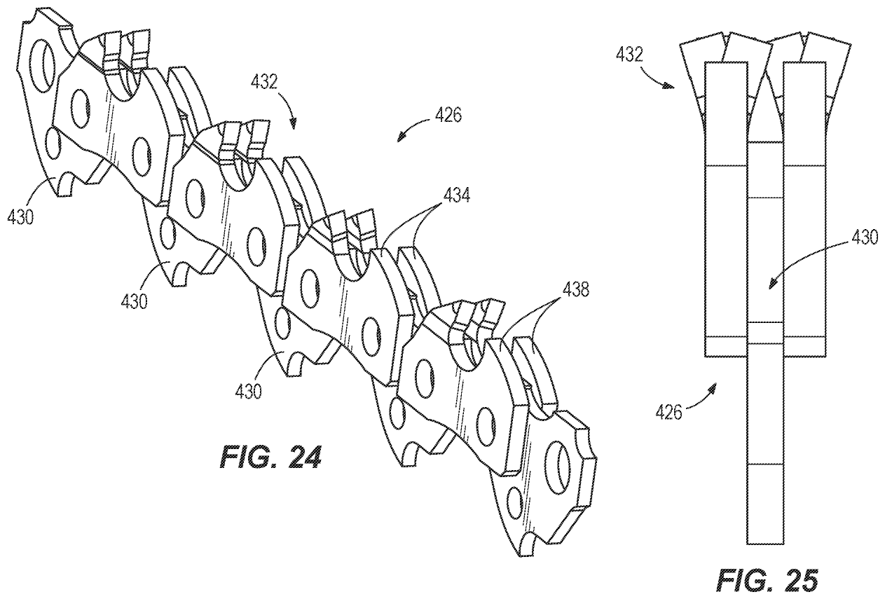

In reference to FIGS. 24 and 25, another embodiment of a chainsaw chain 426 includes a plurality of drive links 430 positioned along a central portion of the chainsaw chain 426 and a plurality of cutters 432, similar to the cutter 318 of the FIG. 16, positioned along both sides of the plurality of drive links 430. The plurality of cutters 432 includes a first set of cutters 434 set in a left direction and a second set of cutters 438 set in a right direction. Each set of cutters 434, 438 is formed by a pair of cutters that are parallel to each other. As such, cutting teeth of the first set of cutters 434 are longitudinally aligned and cutting teeth of the second set of cutters 438 are longitudinally aligned. At least one drive link of the plurality of drive links 430 is disposed between the pair of cutters to maintain the chainsaw chain 426 along the guide bar 34 of the chainsaw 10. In other embodiments, the chainsaw chain 426 includes a third set of cutters having a pair of cutters, in which one of the pair of cutters is set in a left direction and the other of the pair of cutters is set in a right direction. The cutting teeth of each set of cutters 434, 438 can be oriented to either extend over the central portion of the chainsaw chain 426 or to extend away from the central portion of the chainsaw chain 426.

To form the cutting pattern of the chainsaw chain 426, the first set of cutters 434 alternates with the second set of cutters 438 along the chainsaw chain 426. In another embodiment of the chainsaw chain 426, the cutting pattern alternates between a plurality of the first set of cutters and a plurality of the second set of cutters. In other embodiments of the chainsaw chain 426, the cutting pattern alternates between the first set of cutters 434, the second set of cutters 438, and the third set of cutters.

In another embodiment of the chainsaw chain 426, the plurality of cutters 432 is formed by a fourth set of cutters, in which the cutters have cutting teeth that are not set in either the right direction or the left direction. Rather, the cutting teeth of the fourth set of cutters extend upward and parallel to a vertical axis of the respective cutters. Therefore, the cutting pattern of the chainsaw chain 426 alternates between the third set of cutters and the fourth set of cutters.

In each embodiment of the chainsaw chain 426, the cutting pattern of the chainsaw chain 426 does not include tie straps 50 (FIG. 2). The plurality of tie straps 50 is configured to interconnect consecutive drive links 430 to provide spacing between consecutive cutters 432. Without the tie straps 50, the cutting pattern of the chainsaw chain 426 can consist of different sets of cutters adjacent each other. Therefore, a substantial gap is not defined between consecutive cutters 432. Assembling the chainsaw chain 426 without tie straps 50 will increase the number of components configured to perform cutting operations.

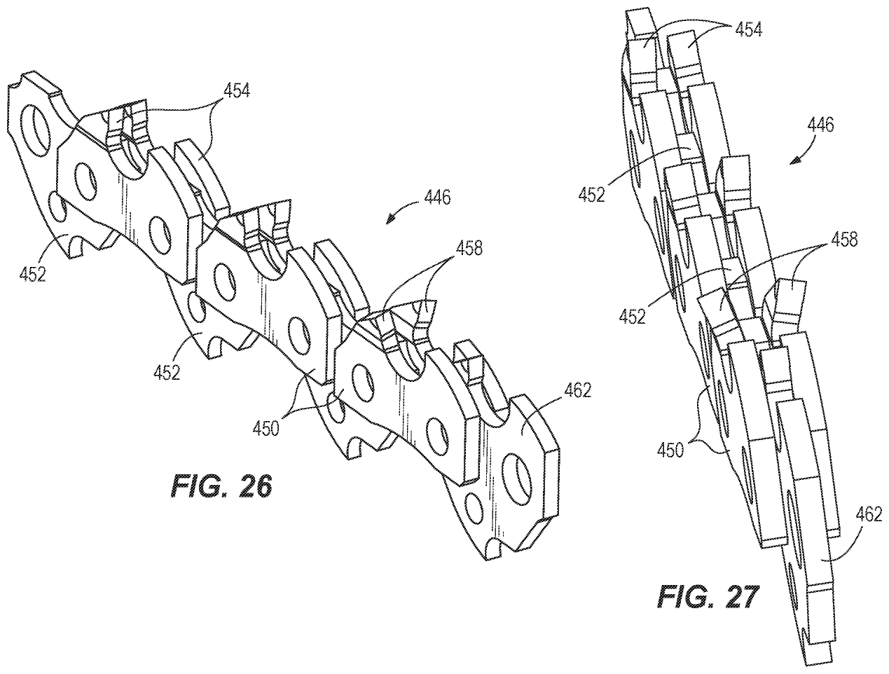

FIGS. 26 and 27 illustrate another embodiment of a chainsaw chain 446. The chainsaw chain 446 includes a plurality of cutters 450 similar to the cutter 318 of FIG. 16 and a plurality of drive links 452 positioned along a central portion of the chainsaw chain 446. The plurality of cutters 450 is positioned along both sides of the plurality of drive links. The plurality of cutters 450 includes a first set of cutters 454 and a second set of cutters 458, in which each set of cutters is formed by a pair of cutters that are parallel. As such, cutting teeth of the first set of cutters 454 are longitudinally aligned and cutting teeth of the second set of cutters 458 are longitudinally aligned. The first set of cutters 454 is configured to extend toward the central portion of the chainsaw chain 446. The second set of cutters 458 is configured to extend away from the central portion of the chainsaw chain 446. At least one drive link of the plurality of drive links 452 is disposed between the pair of cutters. The chainsaw chain 446 further includes a plurality of center cutters 462 represented by a center cutter 462. The plurality of center cutters 462 is similar to the center cutter 402 of FIGS. 21 and 22. The plurality of center cutters 462 is also positioned along the central portion of the chainsaw chain 446, specifically in a space defined between the pair of cutters of the second set of cutters 458. To form the cutting arrangement of the chainsaw chain 446, the first set of cutters 454 alternates with the second set of cutters 458 along a length of the chainsaw chain 446.

Again, the illustrated embodiment does not include the plurality of tie straps 50 (FIG. 2). Therefore, consecutive sets of cutters are adjacent each other. There is no substantial spacing between consecutive cutters 450. As such, the chainsaw chain 446 is configured to have more cutting components.

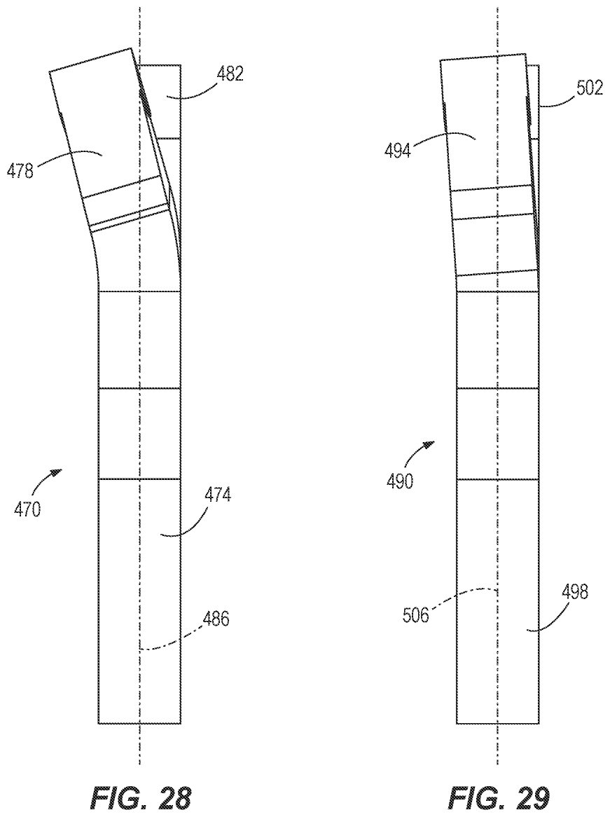

FIG. 28 illustrates a cutter 470 for a chainsaw chain. The cutter 470 has a similar structure as the cutter 318 of FIG. 16. The cutter 470 includes a cutter body 474 having one or more rivet holes extending therethrough, a cutting tooth 478, a cutting tip coupled to the cutting tooth, a feed limiter 482 integrally formed with the cutter body 474 and opposite the cutting tooth 478, a toe, a heel, and a gullet positioned between the feed limiter 482 and the cutting tooth 478. The cutter body 474 defines a longitudinal axis extending through the rivet holes and a vertical axis 486 extending perpendicular to the longitudinal axis. In relation to the vertical axis 486, the cutting tooth 478 is oriented at an oblique angle defined by a first magnitude. In the illustrated embodiment, the oblique angle is, for example, about 15 degrees. The cutting tooth 478 is also set in a left direction relative to the cutter body 474.

FIG. 29 illustrates another embodiment of a cutter 490 for a chainsaw chain. The cutter 490 has a similar structure as the cutter 318 of FIG. 16. The cutter 490 includes a cutting tooth 494, a cutter body 498 having one or more rivet holes extending therethrough, a cutting tip coupled to the cutting tooth 494, a feed limiter 502 integrally formed with the cutter body 498 and opposite the cutting tooth 494, a toe, a heel, and a gullet positioned between the feed limiter 502 and the cutting tooth 494. The cutter body 498 defines a longitudinal axis extending through the rivet holes and a vertical axis 506 oriented perpendicular to the longitudinal axis. The cutting tooth 494 is set in a left direction relative to the cutter body 498, as the cutting tooth 494 is positioned at an oblique angle relative to the cutter body 498 at a second magnitude. In the illustrated embodiment, the oblique angle is, for example, about 5 degrees such that the second magnitude is less than the first magnitude of the cutter 470 (FIG. 28).

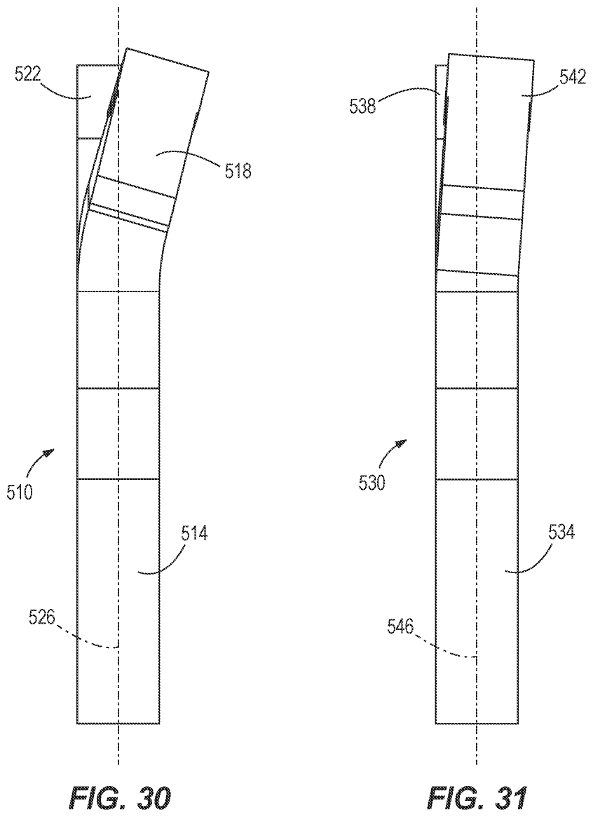

FIG. 30 illustrates another embodiment of a cutter 510 for a chainsaw chain. The cutter 510 has a similar structure as the cutter 318 of FIG. 16. The cutter 510 includes a cutter body 514 having one or more rivet holes extending therethrough, a cutting tooth 518 integrally formed with the cutter body 514, a cutting tip coupled to the cutting tooth 518, a feed limiter 522 integrally formed on the cutter body 514 and opposite the cutting tooth 518, a toe, a heel, and a gullet positioned between the feed limiter 522 and the cutting tooth 518. The cutter body 514 defines a longitudinal axis extending through the rivet holes and a vertical axis 526 oriented perpendicular to the longitudinal axis. The cutting tooth 518 is positioned at an oblique angle relative to the vertical axis 526, in which the oblique angle is defined as the first magnitude. In the illustrated embodiment, the oblique angle is, for example about 15 degrees. Additionally, the cutting tooth 518 is set to extend in a right direction.

FIG. 31 illustrates another embodiment of a cutter 530 for a chainsaw chain. The cutter 530 has a similar structure as the cutter 318 of FIG. 16. The cutter 530 includes a cutter body 534 having one or more rivet holes extending therethrough, a feed limiter 538, a cutting tooth 542 coupled to the cutter body 534, a cutting tip coupled to the cutting tooth 542, a toe, a heel, and a gullet positioned between the feed limiter 538 and the cutting tooth 542. The feed limiter 522 is coupled to the cutter body 534 and opposite the cutting tooth 542. The cutter body 534 of the cutter 530 defines a longitudinal axis extending through the rivet holes and a vertical axis 546 oriented perpendicular to the cutter body 534. The cutting tooth 542 extends in a right direction and is oriented at an oblique angle relative to the vertical axis 546 at a second magnitude. In the illustrated embodiment, the oblique angle is, for example about 5 degrees such that the second magnitude is less than the first magnitude of the cutter 510 (FIG. 30).

In the embodiments of FIGS. 28-31, the cutting teeth 478, 518 of respective cutters 470, 510 are structured such that the cutting tooth 478, 518 is taller than the feed limiter 482, 522 by a first amount. In comparison to the cutters 490, 530 having respective cutting teeth 494, 542 that are taller than the respective feed limiters 502, 538 by a second amount that is less than the first amount. The differences in height may be affected by the set magnitude of the cutting teeth 478, 494, 518, 542. In some embodiments, the cutting teeth 478, 494, 518, 542 may have other heights relative to each other, regardless of set magnitude. For example, some of the cutting teeth 478, 494, 518, 542 may be relatively short, while other cutting teeth 478, 494, 518, 542 may be relatively tall. Cutters with different height cutting teeth may be arranged in various patterns along the length of a chainsaw chain.

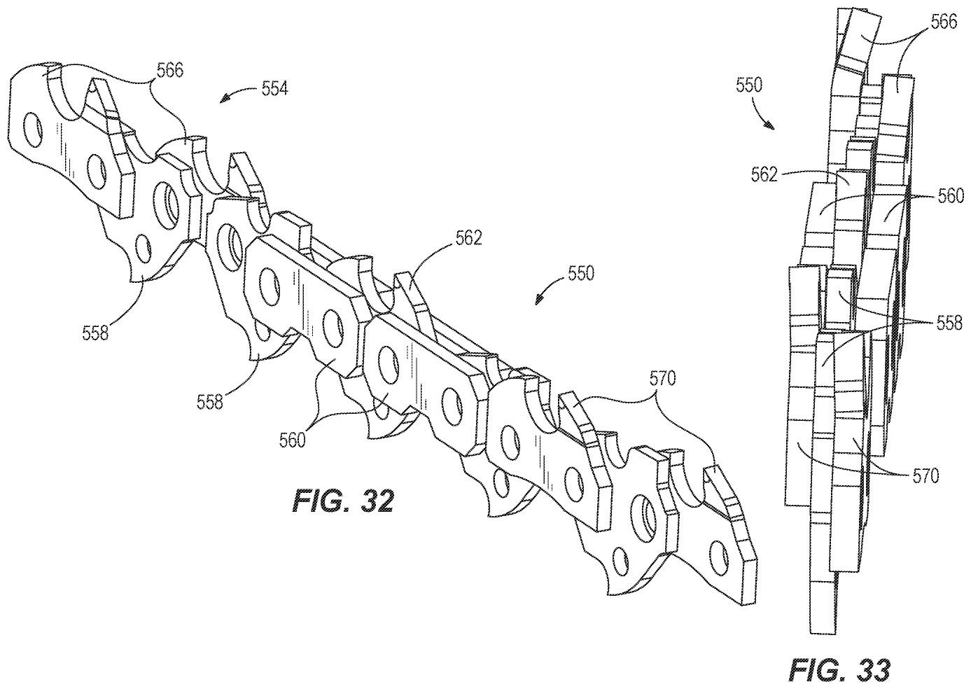

In reference to FIGS. 32 and 33, another embodiment of a chainsaw chain 550 is illustrated. The chainsaw chain 550 includes a plurality of cutters 554, a plurality of drive links 558, a plurality of tie straps 560 configured to interconnect consecutive drive links of the plurality of drive links 558, and a plurality of center cutters 562. The plurality of cutters 554 includes a first set of cutters 566 with cutting teeth oriented in a right direction and a second set of cutters 570 with cutting teeth oriented in a left direction. In other embodiments of the chainsaw chain 550, the chain 550 can include a third set of cutters having cutters with cutting teeth that are unset and extend upright, rather than set in the left direction or the right direction. The plurality of tie straps 560 are defined as a pair of ties straps parallel with each other, such that a gap is defined therebetween. The plurality of center cutters 562 are positioned within the gap defined by the pair of tie straps 560.

With the plurality of cutters 554 and the plurality centers cutters 562, the chainsaw chain 550 is structured to have more components configured to make cutting operations. In this case, either the plurality of cutters 554 or the plurality of center cutters 562 can be used for scoring operations or cutting operations. This arrangement of the chainsaw chain 550 will also provide a variable pitch by adjusting the position of the cutters 554 with respect to the position of the rivets along the chainsaw chain 550.

In the embodiments of FIGS. 12, 17-20, 24-27, and 32-33, the chainsaw chains include cutters with cutting teeth that can extend toward a central portion of the respective chainsaw chains when set in either a right direction or a left direction. The chainsaw chains further include a plurality of drive links that are positioned along the central portion. To ensure that the drive links are not obstructing the cutting path of the cutters, clearance between the cutters and the drive links is created by removing material off a top portion of the drive links.

Although the invention has been described in detail with reference to certain preferred embodiments, variations and modifications exist within the scope and spirit of one or more independent aspects of the invention as described.

What is claimed is:

1. A chainsaw chain for a chainsaw, the chainsaw chain comprising:
a plurality of drive links configured to connect the chainsaw chain to the chainsaw, each drive link including a drive link body, a pair of rivet holes extending through the drive link body, and a tang extending from the drive link body and configured to engage a drive element of the chainsaw;
a plurality of cutters configured to cut a workpiece during a cutting operation, each cutter including
a cutter body having a pair of rivet holes extending therethrough, the cutter body defining a longitudinal axis extending through the pair of rivet holes and a vertical axis oriented perpendicular to the longitudinal axis,
a cutting tooth coupled to an upper portion of the cutter body, the cutting tooth of at least one of the plurality of cutters being set relative to the vertical axis of the cutter body,
a feed limiter coupled to the upper portion of the cutter body and spaced from the cutting tooth, and
a gullet defined between the cutting tooth and the feed limiter; and
a plurality of rivets received within corresponding rivet holes of the plurality of drive links and the plurality of cutters to couple the plurality of drive links and the plurality of cutters together.

2. The chainsaw chain of claim 1, further comprising a plurality of tie straps, wherein each tie strap includes a tie strap body and a rivet hole extending through the tie strap body, and wherein the plurality of rivets is also received within corresponding rivet holes of the plurality of tie straps to couple the plurality of drive links, the plurality of cutters, and the plurality of tie straps together.

3. The chainsaw chain of claim 1, wherein the cutting tooth of at least one of the plurality of cutters is set in a first direction relative to the vertical axis, and wherein the cutting tooth of at least one of the plurality of cutters is set in a second direction relative to the vertical axis that is opposite the first direction.

4. The chainsaw chain of claim 3, wherein the at least one of the plurality of cutters having the cutting tooth set in the first direction is positioned on a first side of the plurality of drive links, and wherein the at least one of the plurality of cutters having the cutting tooth set in the second direction is positioned on a second side of the plurality of drive links opposite the first side.

5. The chainsaw chain of claim 3, wherein the at least one of the plurality of cutters having the cutting tooth set in the first direction and the at least one of the plurality of cutters having the cutting tooth set in the second direction are positioned on a same side of the plurality of drive links.

6. The chainsaw chain of claim 3, wherein the cutting tooth of at least one of the plurality of cutters is unset relative to the vertical axis.

7. The chainsaw chain of claim 1, and wherein the cutting tooth of the at least one of the plurality of cutters is oriented to overlap the plurality of drive links.

8. The chainsaw chain of claim 1, wherein the cutting tooth of the at least one of the plurality of cutters is oriented to extend in a direction away from the plurality of drive links.

9. The chainsaw chain of claim 1, wherein the cutting tooth of a first cutter of the plurality of cutters is oriented at a first oblique angle relative to the vertical axis, and wherein the cutting tooth of a second cutter of the plurality of cutters is oriented at a second oblique angle relative to the vertical axis, the second oblique angle being less than the first oblique angle.

10. The chainsaw chain of claim 1, wherein the cutting tooth of the at least one of the plurality of cutters is set between 5 degrees and 15 degrees relative to the vertical axis.

11. The chainsaw chain of claim 1, wherein the cutting tooth of a first cutter of the plurality of cutters is taller than the feed limiter by a first amount, and wherein the cutting tooth of a second cutter of the plurality of cutters is taller than the feed limiter by a second amount that is less than the first amount.

12. A chainsaw chain for a chainsaw, the chainsaw chain consisting of:
a plurality of drive links configured to support the chainsaw chain on the chainsaw, each drive link including a drive link body, a rivet hole extending through the drive link body, and a tang extending from the drive link body and configured to engage a drive element of the chainsaw;
a plurality of cutters configured to cut a workpiece during a cutting operation, each cutter including
a cutter body having a rivet hole extending therethrough,
a cutting tooth coupled to an upper portion of the cutter body,
a feed limiter coupled to the upper portion of the cutter body and spaced from the cutting tooth, and
a gullet defined between the cutting tooth and the feed limiter; and
a plurality of rivets received within corresponding rivet holes of the plurality of drive links and the plurality of cutters to couple the plurality of drive links and the plurality of cutters together.

13. The chainsaw chain of claim 12, wherein the plurality of cutters is positioned along both sides of the plurality of drive links.

14. The chainsaw chain of claim 13, wherein the plurality of cutters positioned along a first side of the plurality of drive links is staggered relative to the plurality of cutters positioned along a second side of the plurality of drive links such that the cutting tooth of a cutter positioned on the first side is longitudinally offset from the cutting tooth of an adjacent cutter positioned on the second side.

15. The chainsaw chain of claim 13, wherein the plurality of cutters is positioned along both sides of the plurality of drive links in parallel such that the cutting tooth of a cutter positioned on a first side of the plurality of drive links is longitudinally aligned with the cutting tooth of an adjacent cutter positioned on a second side of the plurality of drive links.

16. The chainsaw chain of claim 12, wherein the cutting teeth of at least some of the plurality of cutters are set relative to the feed limiters.

17. A chainsaw chain for a chainsaw, the chainsaw chain comprising:
a plurality of drive links configured to connect the chainsaw chain to the chainsaw, each drive link including a drive link body, a rivet hole extending through the drive link body, and a tang extending from the drive link body and configured to engage a drive element of the chainsaw, at least some of the plurality of drive links also including a cutting tooth extending from an edge of the drive link body opposite from the tang, the cutting tooth configured to cut a workpiece during a cutting operation;
a plurality of cutters configured to cut the workpiece during the cutting operation, each cutter including a cutter body having a rivet hole extending therethrough and a cutting tooth coupled to the cutter body; and
a plurality of rivets received within corresponding rivet holes of the plurality of drive links and the plurality of cutters to couple the plurality of drive links and the plurality of cutters together.

18. The chainsaw chain of claim 17, wherein the at least some of the plurality of drive links further includes a feed limiter extending from the edge of the drive link body and spaced from the cutting tooth, and a gullet defined between the cutting tooth and the feed limiter.

19. The chainsaw chain of claim 17, wherein the at least some of the plurality of drive links further includes a cutting tip coupled to the cutting tooth.

20. The chainsaw chain of claim 19, wherein the cutting tip is formed of carbide.

21. The chainsaw chain of claim 17, wherein each drive link also includes an opening proximate the tang, and wherein the opening is configured to carry and spread lubricating fluid.

22. The chainsaw chain of claim 17, wherein each cutter further includes a feed limiter coupled to the cutter body and spaced from the cutting tooth, and a gullet defined between the cutting tooth and the feed limiter.

23. The chainsaw chain of claim 17, further comprising a plurality of tie straps, wherein each tie strap includes a tie strap body and a rivet hole extending through the tie strap body, and wherein the plurality of rivets is also received within corresponding rivet holes of the plurality of tie straps to couple the plurality of drive links, the plurality of cutters, and the plurality of tie straps together.

24. A chainsaw chain for a chainsaw, the chainsaw chain comprising:
a plurality of drive links configured to connect the chainsaw chain to the chainsaw, each drive link including a drive link body, a rivet hole extending through the drive link body, and a tang extending from the drive link body and configured to engage a drive element of the chainsaw;
a plurality of cutters configured to cut a workpiece during a cutting operation, each cutter including
a cutter body having a rivet hole extending therethrough,
a cutting tooth coupled to an upper portion of the cutter body,
a feed limiter coupled to the upper portion of the cutter body and spaced from the cutting tooth, and
a gullet defined between the cutting tooth and the feed limiter,
the plurality of cutters being positioned along both sides of the plurality of drive links in parallel such that the cutting tooth of a cutter positioned on a first side of the plurality of drive links is longitudinally aligned with the cutting tooth of an adjacent cutter positioned on a second side of the plurality of drive links; and
a plurality of rivets received within corresponding rivet holes of the plurality of drive links and the plurality of cutters to couple the plurality of drive links and the plurality of cutters together.

25. The chainsaw chain of claim 24, wherein the cutting tooth of the cutter and the cutting tooth of the adjacent cutter are set relative to their corresponding feed limiters in a same direction.

26. The chainsaw chain of claim 24, wherein the cutting tooth of the cutter and the cutting tooth of the adjacent cutter are set relative to their corresponding feed limiters in opposite directions.

27. The chainsaw chain of claim 24, wherein the cutting tooth of the cutter the cutting tooth of the adjacent cutter are unset relative to their corresponding feed limiters.

28. The chainsaw chain of claim 24, wherein the cutting tooth of at least one cutter is set relative to the feed limiter to overlap the plurality of drive links.

29. The chainsaw chain of claim 24, wherein the cutting tooth of at least one cutter is set relative to the feed limiter to extend in a direction away from the plurality of drive links.

30. The chainsaw chain of claim 24, wherein a at least one of the plurality of drive links also include a cutting tooth extending from an edge of the drive link body opposite the tang, and wherein the cutting tooth is configured to cut the workpiece during the cutting operation.

31. The chainsaw chain of claim 24, further comprising a plurality of tie straps, wherein each tie strap includes a tie strap body and a rivet hole extending through the tie strap body, and wherein the plurality of rivets is also received within corresponding rivet holes of the plurality of tie straps to couple the plurality of drive links, the plurality of cutters, and the plurality of tie straps together.
